(19) United States
(12) Patent Application Publication
(10) Pub. No.: US 2019/0255426 A1
(43) Pub. Date: Aug. 22, 2019

(54) METHOD OF TEACHING PRE-SCHOOLERS AND ESL STUDENTS COUNTING AND SPELLING SKILLS WITH A MODIFIED DECK OF CARDS

(71) Applicant: Holly A. Scarpa, Greensburg, PA (US)

(72) Inventor: Holly A. Scarpa, Greensburg, PA (US)

(21) Appl. No.: 16/400,177

(22) Filed: May 1, 2019

Related U.S. Application Data
(63) Continuation-in-part of application No. 15/786,337, filed on Oct. 17, 2017, now abandoned.

(51) Int. Cl. A63F 1/04; A63F 1/02; G09B 19/02; G09B 19/08; G09B 1/00

(52) U.S. Cl. CPC A63F 1/04; A63F 1/02; G09B 19/02; G09B 19/08; A63F 2001/0441; A63F 2001/0408; A63F 2001/0416; A63F 2001/0475; G09B 1/00

(57) ABSTRACT

This method for teaching counting and spelling uses an improved deck of cards for use with the game of Trash. But instead of a standard deck of 52 with numerical and face cards, it uses numbered cards, each with an Arabic numeral and its corresponding spelling beneath. There are also Wild Cards, Trash Cards and score-keeping Winner cards. The method for playing this card game can include expansion packs beyond the basic (1 through 10) set and/or foreign language equivalents.

### CROSS-REFERENCE TO RELATED APPLICATIONS

This is a continuation-in-part from co-pending application Ser. No. 15/786,337, filed on Oct. 17, 2017, which was a perfection of U.S. Provisional Application Ser. No. 62/409,229, filed on Oct. 17, 2016, both disclosures of which are fully incorporated by reference herein.

### BACKGROUND OF THE INVENTION

### 1. Field of the Invention

The present invention relates to a card game and a method of playing it. More particularly, it pertains to an improved counting card game with both entertainment and educational value. It is a significant improvement over the known game called “Trash” (or sometimes “Garbage”) whose rules are listed below. As proposed, this invention offers an ability to teach young children, especially pre-school aged toddlers, counting and other language skills in English and selected foreign dialects. It would also serve as a good teaching tool for ESL (English Second Language) students, regardless of age. One of the names being considered for marketing these cards is Trash Talking™.

### 2. Description of the Prior Art

The use of card games for entertainment is known in the art. Numerous educational card games have also been devised, made and sold. The card game of the present invention departs from conventional concepts in so much as it was developed for both entertainment and educational value. Though other such combination card games exist, this invention helps make preschoolers learn their counting skills in both English and other languages fun!

### SUMMARY OF THE INVENTION

The present invention provides an improved counting card game, particularly one that is readily expandable and multi-lingual. It constitutes an improvement over playing the basic card game Trash with a standard deck of 52 playing cards with both numerical and face cards. It replaces the latter (wasted) face cards for Trash playing by two or more players using more practical, and more competitive alternatives like designated TRASH cards, Wild Cards and Winner tracking cards, or the like. In the counting version of this game, each card face will have an Arabic numeral and a word spelling corresponding to that numeral for the children to learn counting and the proper spelling for such words. Foreign languages equivalents are also anticipated hereby.

There has thus been outlined, rather broadly, the more important features of the present invention. The detailed description that follows may be better understood in the context of what this inventor hopes to achieve with her NEW deck of card designs, expansion packs and related methods of play. There are, of course, additional features (some optional) of the invention that will be described hereinafter and which will form the subject matter of the claims appended hereto.

Before explaining at least one embodiment in detail, it is to be understood that this invention is not limited in its application to the specific details of construction and/or to the arrangements of components set forth in the following description and drawings. This invention is capable of still other embodiments and of being practiced or carried out in various ways. Also, it is to be understood that the phraseology and terminology employed herein are for the purpose of description and should not be regarded as limiting.

It is therefore an object of the present invention to provide a new and improved card game that has all the advantages of the prior art Trash game while making still further improvements thereto. It enables fuller, more comprehensive play that Trash playing with a standard deck of 52 cards does not/cannot. It is also readily expandable based on the number of players, the set of numbers to be taught and/or the foreign language equivalents desired.

It is another object of the present invention to provide a new and improved card game that may be easily and efficiently manufactured and marketed.

A further object of the present invention is to provide a new and improved card game which would be low cost to customize, make, market and sell, and which could be expandable, thereby making such card game economically available to the buying public. Still another object is to provide a game with both entertainment and educational value.

The present invention consists of a new and improved card game with a plurality of options to the basic Trash game. It uses no face cards from a standard playing deck of 52 cards (in four suits) or the standard pair of 2 jokers, but instead uses 54 cards . . . four of each numbered card (2 through 10), with the Ace replaced by a “one” card for each suit, a “trash” card replacing the eight jacks and queens, and a “wild card” replacing all four kings and two jokers, six in total. In addition, “Winner” cards are included for allowing the players to keep better track of who “won” the preceding game (the rules and reductions in card counts will let them keep track of previous individual round winners).

The typical playing deck for this modified Trash alternative would have playing cards, from one to ten, maybe in different suits, symbols or colors with the understanding that two players could use a first, standard deck size. If more than two players are involved, the inventor recommends another (second) deck be included for a third or fourth player and a third (extra) deck for five or six players.

In addition to the standard counting deck from One to Ten, additional expansion packs would be available that would expand learning to the next set of ten, i.e., packs for 11-20, 21-30, 31-40 and so on.

For an international flair, preferred embodiments of these cards would include other language equivalents to the face values of the respective cards so that, in addition to learning the word ONE for the value “1”, a Spanish deck, an Italian deck, a French deck or a German deck would have their equivalents also displayed. Most any language would work: Japanese, Mandarin, Greek, Russian, Arabic, etc. When foreign languages are incorporated into such decks, they may or may not include English translations should a parent/teacher want to expose their child/student to interchanges in more than one language. This could also apply to the aforementioned expansion packs.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings in which:

FIG. 1 is a top plan view of six representative playing cards (of various values) with their foreign language equivalents displayed thereon; and

FIG. 2 is a top plan view showing several representative cards for improved Trash play, replacing face cards with Trash, Wild Card and Winner variations.

### DESCRIPTION OF PREFERRED EMBODIMENTS

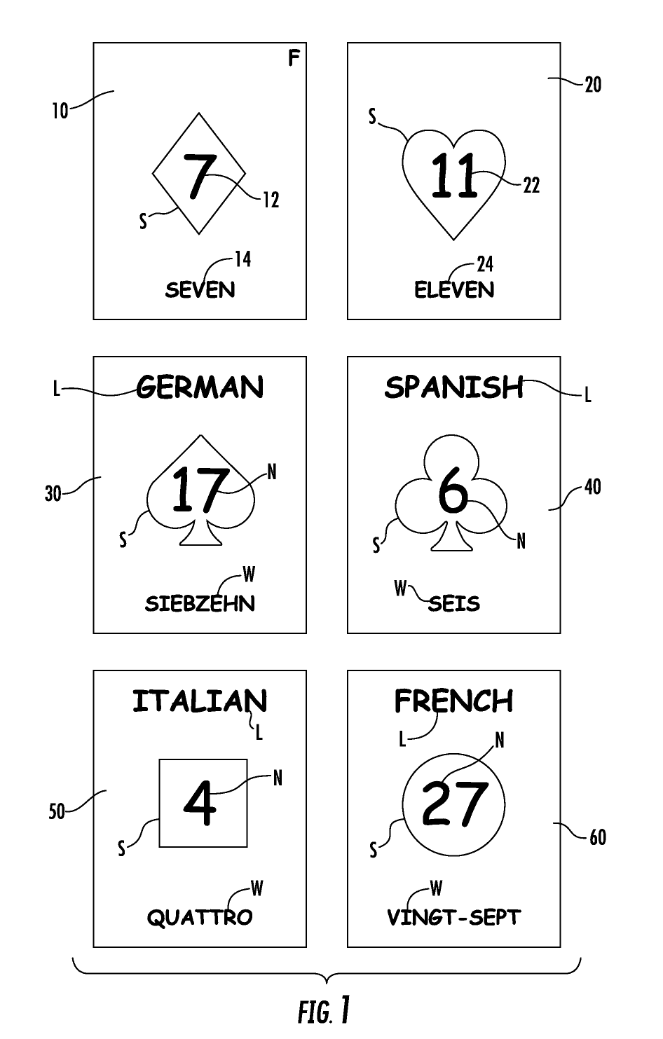

With reference to the drawings, and in particular to the cards at FIG. 1, a new and improved counting game embodying the principles and concepts of the present invention will be described. The present invention, the new and improved counting card game, is comprised of a plurality of components. Such components in their broadest context include a plurality of cards but no score sheets and/or timer. Such components are individually configured and correlated with respect to each other so as to attain the desired objective.

With respect to the above description, it is to be realized that the optimum dimensional relationships for the parts of the invention, i.e., the playing/counting cards, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Referring now to FIG. 1, there is shown a first card 10 in the standard, “starter” set of 54. It has on its card front F, an Arabic numeral 12, in this case, the number 7. Below that number for this particular, representative card 10 is a word spelling 14 for the corresponding numeral 12, in this case “SEVEN”.

To the right of the starter card 10 of FIG. 1, there is shown a second representative card from a first expansion pack that would cover the teaching of numerals 11 through 20. Card 20 in FIG. 1 shows its own expansion pack numeral 22, in that case the number 11. Below it would be the corresponding word spelling 24, “ELEVEN”. Additional expansions can be made available in still other TEN PACK's. Particularly, after the children have mastered their initial 1-10 counting, and corresponding spellings, parents could encourage further fun learning through the addition of other English number packs.

Note that each set of ten counting cards may be identified with corresponding symbols S. A common version would match those normally used in most other card games, varying by suit: diamond, heart, spade and club. Alternately, the four starting sets (for a two player game—or more sets when counting with additional, i.e. more than two, players) may be identified via different color printings (beyond the standard red and black for the suits listed above) and/or fonts. Still other sets of ten may vary with the inclusion/incorporation of differing symbols (cars, boats, teddy bears, etc.) for the different sets of 10 starter cards. See, for example, the square symbol S for the Italian language card and a circle symbol S for the French card shown elsewhere in FIG. 1.

Below English starter card 10 and first representative expansion pack card 20 are four foreign language representative cards: German card 30, Spanish card 40, Italian card 50 and French card 60. Even though only four representative languages are shown in accompanying FIG. 1, it is understood that most any language may be used on these teaching cards, including but not limited to: Japanese, Chinese, Arabic, Portuguese and Greek.

Each of the foreign language cards includes at least one language caption L across their top for designating from which they are translating, plus an Arabic numeral N along with a word spelling W of that same specific numeral. Note particularly, the German designation for “17”, the Spanish “6”, the Italian “4” and French “27” on these representative cards. Though not shown, they may also include an English AND foreign language spelling of the same numeral should a parent/teacher want to use such cards in an ESL setting or to assist at teaching counting and spelling in a household where other than English is spoken as the primary language.

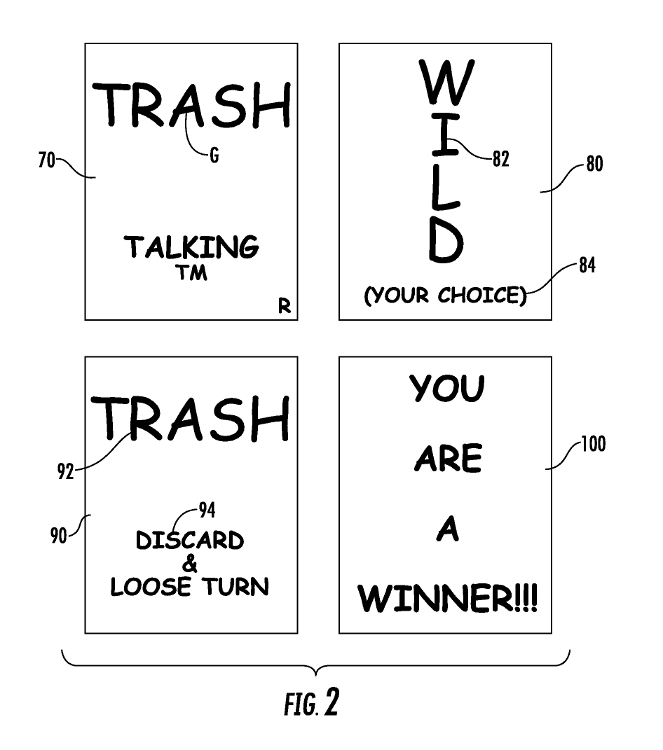

FIG. 2 shows four additional cards from a playing card set, the first card 70 being the deck cover card with a proposed game name G, “TRASH TALKING” emblazoned across. This could actually serve as the rear face R to all cards from a given playing card set.

To the right of the rear face R of all game cards, actually card 70 in FIG. 2, there is included a representative wildcard 80, with its legend notation “WILD”, 82, and parenthetical instruction 84 “(YOUR CHOICE)” also shown thereon. The game namesake card, or TRASH card 90, has its own notation 92, shown in ALLCAPS (though it understood that other fonts and designations may be used instead), and its own explanation 94 (though not parenthetical, as shown) there beneath. Finally, card 100 is an indicator that one of the players has won that particular game, it is the “YOU ARE A WINNER!” card and can be used as a record for keeping track of which player won the most games in a given day of playing.

### Typical Rules for “Trash”

1. Deal 10 cards to each person (2 players per deck of cards); Place the 10 cards face down in 2 rows of 5 cards for the first round/hand.
2. The first player draws a top card from the remainder of the un-dealt deck. If that card is a 7, for example, that player: (a) uses the drawn card in the seventh spot of his/her 10 face down cards, (b) places the drawn face up 7-card in that slot and then (c) picks up the face down card already there and flips it over. If that now flipped over card was a 4, for example, the same player can proceed to use it in his/her fourth slot (of ten) and proceed further by flipping over the currently face down #4 card and so on. If the formerly face down card in the player's original #7 slot is another 7, he/she must discard it and it becomes the next player's turn. If the now turned over #7 card is a Trash card, it must also be discarded and that player still loses his/her turn to continue flipping cards from the original stack of 10 dealt cards.
3. If the drawn card or flipped over/exposed card is a Wild card, that player can use his or her Wild card in any of the slots, including a previously played slot, for continuing his or her turn for that given round of card play.

### Ways to Win

1. The first player to get all 10 cards first (regardless of suit/symbol) wins that round (see, item 3 above). Once that first round is complete, the next round would be played with only 9 cards down for the player who won the preceding round while the other player gets their full allotment of ten dealt, face down cards. The player with one less card (for this round) will only need to find/replace all 9 cards (1-9) for winning that hand (while the other would still need to match out all ten dealt cards. A known variation of this is that all players get to reduce their number of cards needed for the next hand/round.
2. For each successive round/hand, the winner will only need to match one less number of dealt cards, 9, then 8, then 7 and so on until in a potentially final round, that same person will have only one card to match out. Whoever gets that last ONE first would be the overall game winner and get awarded a Winner card for keeping track of the day's sessions.
3. An alternative way to play is for each game to count as 10 points and the players continue with successive rounds/hands until a pre-set target total is met by one player (such as 100 total points, or another agreed-to final tally).

### Trash Talking—Game Examples

In addition to the better numbered (i.e., no ACE, but rather a ONE card, and NO face cards: i.e., King, Queen, Jack), this invention covers different methods of playing a modified game (i.e., multiple ROUNDS/HANDS) of Trash. Since there is a preference for international language teaching . . . as well as counting numbers, there is a teaching aspect to playing Trash Talking™ by one or more of the following proposed gaming options:
1. Use just one set (52 or 54) of cards with numbers ranging from 1-10, 11-20, 21-30, etc. In a first preferred version, cards 11-20 are used for the ten card deck deal rather than playing with all 20 numbered cards at once. It would get too cumbersome for smaller children and overly complicate round play when more than 10 cards are used to start a given hand/round.
2. Use multiple decks (especially for 3 or more players, with multiple sets of ten, or numbers ranging from 1-20, or 1-30, etc., especially for older children.
3. Use two or more decks aimed at replacing from the dealt hands the first set of even numbers (2, 4, 6, 8, 10, 12, 14, 16, 18, 20), OR just the first ten odd numbers (1, 3, 5, 7, 9, 11, 13, 15, 17, 19).
4. Use three or more decks aimed at replacing from the dealt hands the first set of PRIME numbers (2, 3, 5, 7, 11, 13, 17, 19, 23, 29).
5. Use three or more decks aimed at replacing from the dealt hands multiples of a given number, such as the first 10 multiples of 3 (3, 6, 9, 12, 15, 18, 21, 24, 27, 30) or still other multiple, e.g. 2, 4 or 5.
6. Still other variations may include non-numbered alternatives proposing (in both English AND a foreign language), only 7 rounds for the days of the week, or 12 rounds for months of the year.
7. If used to teach the letters of the alphabet, the symbols used with a given letter may START with the face card: such as using a Cat figure for “C” and a Dog for “D”.
8. If used to teach geography to older children, consider packs like the first 13 states to ratify the constitution (with pictures of the states included with their names). None of these versions are illustrated in accompanying FIG. 1, however.
9. For older children, it is conceivable to teach chemical symbols of the periodic table with a specially designed CHEMISTRY deck.
10. A historical variation might be to use cards with the U.S. Presidents (the first 10 or in multiple ROUNDS/HANDS, successive groups of 10 until all 45 are played through.
11. Still another variation might be to take any of the aforementioned decks of states, presidents, etc. and play a “Concentration-like” matching game with a whole deck of all 50 states, all 45 presidents flipped down and matched, turn-by-turn, with matching pairs removed and the next round proceeding until all pairs of states/presidents have been duly matched up.
12. Finally, using a match game variation, one deck could use symbols of family members (father, mother, sister, brother, grandfather, etc.), household items, cars and trucks, etc. with pictures of each AND with each item described in at least two languages, English and a preferred foreign language equivalent like one or more of those specified above.

What is claimed is:

1. A method for teaching pre-schoolers and ESL students counting and spelling skills, said method comprising:
(a) providing a first playing deck of at least fifty cards for at least two players, said first playing deck having: (i) at least four sets of ten cards, each set having a common symbol or color identifier and numbered for ten consecutive numerals with one Arabic numeral and a word spelling for that numeral, (ii) a plurality of Trash cards which cause a player to lose their turn when flipped over or drawn; (iii) a plurality of Wild Cards, each of which allows a player to replace a card from their originally dealt cards; and (iv) a plurality of Winner cards, at least one card awarded to each player who completes enough rounds to win a game;
(b) using the first playing deck to play one or more rounds of a card game known as Trash which is otherwise played with a deck of standard playing cards that includes four playing suits, jokers and face cards; and
(c) after completion of one or more rounds of the card game known as Trash, the players review the numerals and word spellings for the winning hand of cards.

2. The method of claim 1 wherein the first playing deck is supplemented with a second playing deck for every pair of additional players after the first two players.

3. The method of claim 1 wherein the first playing deck of at least four sets of ten consecutively numbered cards may be fully replaced by or supplemented with at least four sets of ten additional consecutively numbered cards in a series of ten consecutive numbers after the first ten numbers or in a series of ten consecutive numbers unrelated to the first ten numbers.

4. A method for teaching pre-schoolers and ESL students counting and spelling skills, said method comprising:
(a) providing a first playing deck of at least fifty cards for at least two players, said first playing deck having: (i) at least four sets of ten cards, each set having a common symbol or color identifier and numbered for ten consecutive numerals with one Arabic numeral and a word spelling for that numeral, (ii) a plurality of Trash cards which cause a player to lose their turn when flipped over or drawn; (iii) a plurality of Wild Cards, each of which allows a player to replace a card from their originally dealt cards; and (iv) a plurality of Winner cards, at least one card awarded to each player who completes enough rounds to win a game;
(b) dealing to each player, in an alternating manner, cards from the first playing deck, face down, until each player has one row of ten, or 2 rows of five cards in front of them;
(c) creating a drawdown deck from the remaining undealt cards;
(d) commencing a round of play in which a first player takes a top card from the drawdown deck: (i) if that card is a numeral, the player places that numeral card, face up, in a comparable slot location in the player's original one row of ten, or two rows of five, before taking the replaced, face down card and flipping it over to see whether it can be played in another of the player's originally dealt card slots for continuing his or her turn or, if not, then turn of the game passes to the next player; (ii) if any drawn or flipped card is a Trash card, the player loses the remainder of his or her turn; and (iii) if any drawn or flipped card is a Wild Card, that player can choose which of the remaining face down cards to replace with the Wild Card; play for a round of the game continuing until one player has replaced over all ten of his or her originally dealt cards; and
(e) after completion of a round, the players review the numerals and word spellings for the winning hand of cards.

5. The method of claim 4 which repeats with a second round in which one less card is dealt, face down, to the player who won the previous round.

6. The method of claim 5 in which card dealing numbers continue to decrease to the previous round winning player until one player has only one dealt card and replaces that dealt card in the last round of play.

7. The method of claim 6 wherein the player who has won a sufficient number of rounds receives a Winner card for winning the game.

8. The method of claim 4 wherein each numbered card of the first playing deck includes a language indicator and a spelling equivalent for the numeral in the language of the language indicator.

9. The method of claim 4 wherein the first playing deck is supplemented with a second playing deck for every pair of additional players after the first two players.

10. The method of claim 4 wherein the first playing deck of at least four sets of ten consecutively numbered cards may be fully replaced by or supplemented with at least four sets of ten additional consecutively numbered cards in a series of ten consecutive numbers after the first ten numbers or in a series of ten consecutive numbers unrelated to the first ten numbers.

11. The method of claim 4, which can be used to teach mathematical sequencing including prime numbers, odd numbers, even numbers and multiples of a number.

12. A method for playing a card game to teach counting and spelling skills in English or a foreign language, said method comprising:
(a) providing a first deck of at least fifty cards for at least two players, said first deck having: (i) at least four sets of ten cards, each set having a common symbol or color identifier and numbered for ten consecutive numerals with one Arabic numeral and a word spelling for that numeral, (ii) a plurality of Trash cards which cause a player to lose their turn when flipped over or drawn; (iii) a plurality of Wild Cards, each of which allows a player to replace a card from their originally dealt cards; and (iv) a plurality of Winner cards, at least one card awarded to each player who completes enough rounds to win a game hereunder;
(b) dealing to each player, in an alternating manner, cards from the deck, face down, until each player has one row of ten, or 2 rows of five cards in front of them;
(c) creating a drawdown deck from the remaining undealt cards;
(d) commencing a round of play with a first player taking a top card from the drawdown deck: (i) if that card is a numeral, the player places that numeral card, face up, in a comparable slot location in the player's original one row of ten, or two rows of five, before taking the replaced, face down card and flipping it over to see whether it can be played in another of the player's originally dealt card slots for continuing his or her turn or, if not, then turn of the game passes to the next player; (ii) if any drawn or flipped card is a Trash card, the player loses the remainder of his or her turn; and (iii) if any drawn or flipped card is a Wild Card, that player can choose which of the remaining face down cards to replace with the Wild Card; play for a round of the game continuing until one player has replaced over all ten of his or her originally dealt cards; and
(e) after completion of a round, the players reviewing the numeral and word spelling on the winning hand of cards.

13. The method of claim 12 which repeats with a second round in which one less card is dealt, face down, to the player who won the previous round.

14. The method of claim 13 in which card dealing numbers continue to decrease to the previous round winning player until one player has only one dealt card and replaces that dealt card in the last round of play.

15. The method of claim 14 wherein the player who has won a sufficient number of rounds receives a Winner card for winning the game.

16. The method of claim 12 wherein each numbered card includes at least one language indicator and a foreign language spelling for the numeral.

17. The method of claim 16 wherein the foreign language is selected from the group consisting of Spanish, French, German, Japanese, Chinese, Arabic, Portuguese, Greek and Italian.
